(19) United States
(12) Patent Application Publication
(10) Pub. No.: US 2020/0391792 A1
(43) Pub. Date: Dec. 17, 2020

(54) USE OF AN ASSIST MOTOR OF A POWER STEERING SYSTEM IN ORDER TO GENERATE TEST CYCLES ACCORDING TO A FORCE ASCERTAINING CYCLE

(71) Applicant: JTEKT EUROPE, Irigny (FR)

(72) Inventors: Matthieu LOUSSAUT, Tassin-La-Demi-Lune (FR); Christophe RAVIER, Saint Pierre De Chandieu (FR)

(73) Assignee: JTEKT EUROPE, Irigny (FR)

(21) Appl. No.: 16/770,733

(22) PCT Filed: Dec. 3, 2018
(86) PCT No.: PCT/FR2018/053086

§ 371 Date: Jun. 8, 2020

(30) Foreign Application Priority Data
Dec. 7, 2017 (FR) 1761761

(51) Int. Cl. B62D 5/04

(52) U.S. Cl. CPC B62D 5/0487; B62D 5/0463

(57) ABSTRACT

A method for characterizing a power steering system for empirically determining at least one property of the system, the power steering system including at least one steering wheel, a steering mechanism provided with a rack, and at least one assist motor, the method including, outside a steering phase during which the power steering system is assigned to the driving of a vehicle in order to cause the vehicle to follow a trajectory which is determined as a function of the situation of the vehicle with respect to its environment, a step (a) of automatically activating the assist motor, during which step a computer is used to automatically generate and apply to the assist motor, without requiring any external action on the steering wheel, an activation instruction that follows one or more cycles referred to as pre-established exploration cycles for measuring.

The present invention concerns the characterization methods intended to empirically determine at least one property of a power steering system, such as for example the position of the end-of-stroke stops of a steering rack or the frequency-response characteristics of the power steering system, during the fine-tuning or the calibration of said system in factory.

The known characterization methods require a human operator installing the power steering system on a test bench, then the latter maneuvering the steering wheel according to pre-established special maneuver cycles so that sensors and recorders equipping the test bench could observe the reactions of the steering system and measure the indicator parameters which then allow quantifying the pursued property.

Of course, such manual maneuvers are sometimes quite tedious, and often relatively inaccurate, to the extent that the operator cannot exert an accurate speed or force setpoint, and in particular a constant value setpoint, in a reliable and repeatable manner, or else he could for example be mistaken about the direction of maneuver during a cycle, which may distort the estimate of the pursued property.

Moreover, while it is possible, in absolute terms, to consider replacing the operator with a robotized arm that actuates the steering wheel, such a solution is particularly complex and expensive to implement, in particular because it is necessary, at each test, to install and couple the robotized arm to the steering wheel, and to materially reconfigure the robotized arm and the test bench according to the model of the tested steering system.

Consequently, the objects assigned to the invention aim at overcoming the aforementioned drawbacks and at providing a method for characterizing a power steering system which allows for a quick, reliable and low-cost characterization of said power steering system.

The objects assigned to the invention also aim at providing a new method for characterizing a power steering system which has a great versatility, as said method adapts in a simple manner to many models of power steering systems and/or allows completely characterizing several properties of the same power steering system.

The objects assigned to the invention are achieved by means of a method for characterizing a power steering system intended to empirically determine at least one property of said power steering system, called «pursued property», said power steering system comprising at least one heading definition device, such as a steering wheel, which allows defining the orientation, called «steering angle» of the power steering system, a steering mechanism provided with at least one movable member, such as a rack, whose position adapts so as to correspond to the selected steering angle, as well as at least one assist motor arranged so as to be able to drive said steering mechanism, said method being characterized in that it comprises, besides a piloting phase during which the power steering system is dedicated to driving of a vehicle in order to make said vehicle follow a path that is determined according to the situation of said vehicle with respect to its environment, a step (a) of automatically activating the assist motor, during which a calculator is used to automatically generate and apply to the assist motor, without requiring any external action on the heading definition device, an activation setpoint which follows one or several pre-established cycle(s) called «exploration cycles», a measurement step (b), according to which is measured, during the exploration cycle(s) or on completion of said exploration cycle(s), at least one physical parameter, called «indicator parameter», which is specific to the response supplied by the power steering system to the automatic activation of the assist motor and which is characteristic of the pursued property, then an analysis step (c), during which the pursued property is quantified from the measurement(s) of the indicator parameter.

Advantageously, the invention thus uses the assist motor itself as a (unique) means to activate the steering mechanism according to the selected exploration cycle(s), without it being necessary to use an auxiliary drive means, and in particular an auxiliary motor, external to the steering system.

Thus, an operator or a robotized arm is no longer necessary.

Furthermore, the automation of the exploration cycles advantageously allows applying to the assist motor, during the phases where the steering system is characterized, particularly accurate setpoints, much more accurate than during manual maneuvers, and in particular predetermined speed, acceleration or force setpoints that are constant over predetermined periods or over displacement distances of the movable member, which allows accurately measuring the indicator parameter(s), without the activation of the power steering system constituting by its very nature a potential source of error that would be related to an excessive and uncontrolled variability of the setpoint with respect to the target ideal exploration cycle.

Hence, the characterization of the pursued property is particularly accurate and repeatable.

Furthermore, the invention allows in particular equipping the power steering system, irrespective of the model of said system, with an onboard calculation module which contains a complete set of characterization functions, for example in the form of a library file stored in a non-volatile memory of said module, such that the power steering system will be intrinsically provided with the tools that are necessary to the characterization thereof, and more generally to the characterization of several ones of its properties.

Hence, the fine-tuning and the calibration of said power steering system will be greatly facilitated.

Other objects, features and advantages of the invention will appear in more detail on reading the following description, as well as using the appended drawings, provided as an illustrative and non-limiting example, among which:

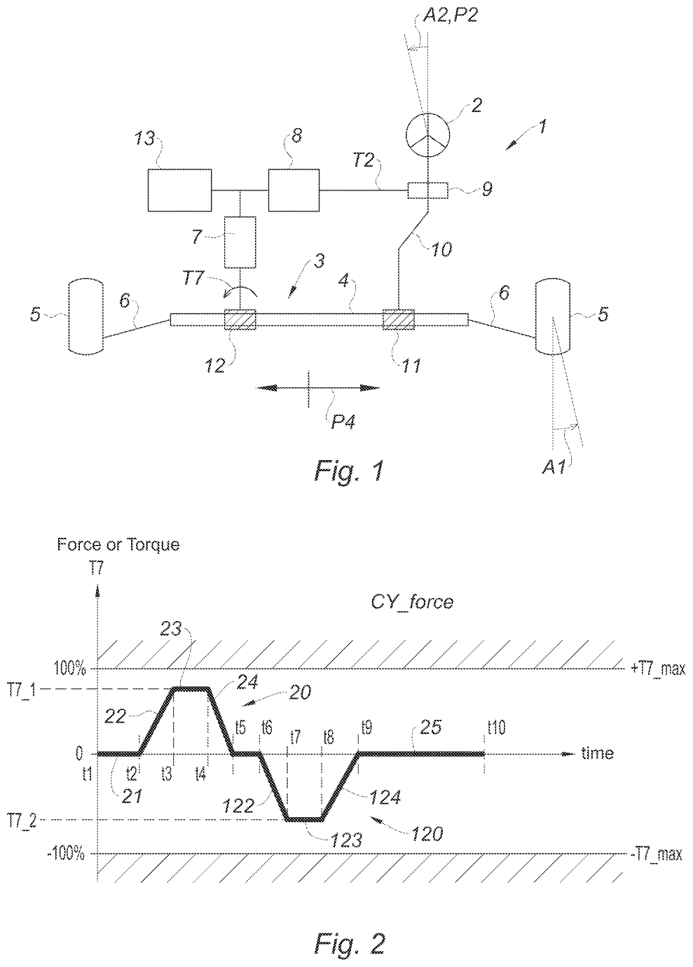

FIG. 1 illustrates, according to a schematic view, a power steering system.

FIG. 2 illustrates an example of a force exploration cycle which represents the evolution over time of a torque setpoint according to which the assist motor is servo-controlled.

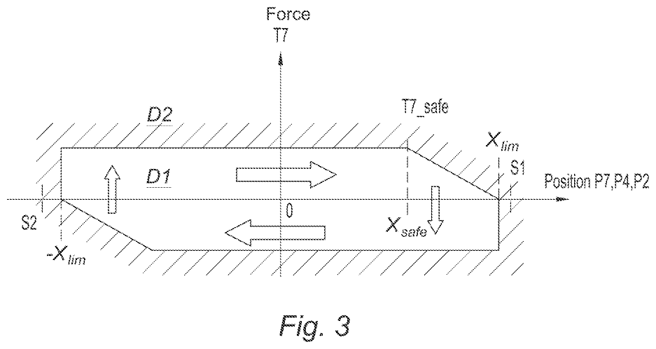

FIG. 3 illustrates a safeguarding function which, by superimposing where needed to the exploration cycles, allows limiting the torque generated by the assist motor when the steering mechanism approaches the end-of-stroke stops.

The invention concerns a method for characterizing a power steering system 1 intended to empirically determine at least one property of said power steering system 1, specific to said system, called «pursued property».

As shown in FIG. 1, said power steering system 1 comprises at least one heading definition device 2 which allows defining the orientation, called «steering angle» A1, of the power steering system.

Preferably, the heading definition device 2 will comprise a steering wheel 2 which enables a driver (human) to freely define said steering angle A1 so as to ensure a manual piloting of a vehicle equipped with the power steering system 1.

Said steering system also comprises a steering mechanism 3 provided with at least one movable member 4, such as a rack 4, whose position P4 adapts so as to correspond to the selected steering angle A1.

For convenience, the movable member 4 may therefore be assimilated to a rack in what follows.

In a manner known per se, said movable member 4, and more particularly the rack 4, may preferably be mounted movable and guided in translation within a steering casing.

Thus, the steering mechanism 3 allows modifying the orientation of an orientable member 5, such as a steered wheel 5, displaced by the rack 4, in order to direct a vehicle on which said power steering system 1 is embedded.

In a manner known per se, the steering mechanism 3 may comprise steering tie rods 6 each linking one end of the rack 4 to a yaw-orientable steering knuckle and carrying the corresponding steered wheel 5.

The power steering system 1 also comprises at least one assist motor 7 arranged so as to be able to drive said steering mechanism 3.

Preferably, said assist motor 7 will consist of an electric motor, with two directions of operation, so as to be able to drive the steering mechanism 3 indifferently to the left or to the right, for example a brushless motor.

Although the use of a linear motor 7 is not excluded, a rotary motor 7 will be preferred.

The assist motor 7 is placed, through a calculator comprising a first onboard module 8, that is to say integrated to the system 1, called «assist module» 8, under the dependence of the heading definition apparatus 2.

Preferably, the heading definition apparatus 2 may serve to define a steering angle setpoint A2, which may typically be defined, in the case where the apparatus 2 comprises a steering wheel 2 or is formed by a steering wheel 2, by the angular position P2 of said steering wheel 2.

Alternatively or complementarily to the supply of a steering setpoint A2, the heading definition apparatus 2 may supply a force datum T2, called «steering wheel torque», which corresponds to the force exerted by the driver on said heading definition apparatus 2, and more particularly to the torque exerted by the driver on the steering wheel 2.

Said steering wheel torque T2 may be measured by a torque sensor 9 associated to the steering wheel 2.

According in particular to the steering angle setpoint A2 and/or where appropriate according to the «steering wheel torque» T2 exerted by the driver on said heading definition apparatus 2, the assist module 8 defines, according to an assist law stored in said assist module 8, an assist force setpoint (assist torque setpoint) T7 applied thereby to the assist motor 7, in order to make the actual steering angle A1 of the system 1, and consequently the yaw angle of the wheels 5, coincide with the orientation defined by the heading definition apparatus 2.

Of course, other parameters, and in particular dynamic parameters of the vehicle, such as the longitudinal speed of the vehicle, may be taken into consideration by the assist law.

It should be noted that the invention may preferably apply to a power steering system within which the steering wheel 2 is mechanically linked to the rack 4 and therefore mechanically linked, at least indirectly, to the assist motor 7, for example through a steering column 10 carrying said steering wheel 2 and provided with a pinion 11 which meshes on the rack 4.

In this manner, the steering wheel 2 is an integral part of the steering mechanism 3, and can transmit a manual steering force and/or a steering movement to the movable member (rack) 4, and conversely, be driven by the assist motor 7.

Alternatively, it is quite possible to consider applying the invention to a power steering system called «steer-by-wire», within which there is no drive mechanical linkage between the steering wheel 2 and the movable member (rack) 4 driven by the assist motor 7, but only an electric link which transmits the steering angle setpoint A2 and/or the steering wheel torque information T2 to the assist module 8 which, in turn, servo-controls the assist motor 7.

The assist motor 7 may be coupled to the rack 4 by any suitable mechanism, and in particular by a motor pinion 12, possibly distinct from the pinion 11 of the steering column, and which directly meshes on the rack 4, as illustrated in FIG. 1, or by a ball screw, or else through a reducer placed on the steering column 10 so as to form a so-called «single-pinion» mechanism.

Whether considering a mechanical linkage steering or a steer-by-wire, the heading definition apparatus 2 intervenes during a phase called «piloting phase», during which the power steering system 1 is effectively dedicated to driving of a vehicle, in order to make said vehicle follow a path that is determined according to the situation of said vehicle with respect to its environment.

According to the invention, the method comprises, besides such a piloting phase, that is to say at the time where the steering system 1, and more generally the vehicle, is not in a traffic situation, and that it is not therefore necessary to take into account the environment of said vehicle to define a vehicle path adapted to such an environment, or to necessary comply with a particular path to ensure safety of the vehicle and of its occupants, a step (a) of automatically activating the assist motor 7, during which a calculator 13 is used to automatically generate and apply to the assist motor 7, without requiring any external action on the heading definition device 2, an activation setpoint which follows one or several pre-established cycle(s) called «exploration cycles» CY, a measurement step (b), according to which is measured, during the exploration cycle(s) CY or on completion of said exploration cycle(s) (CY), at least one physical parameter, called «indicator parameter», which is specific to the response supplied by the power steering system 1 to the automatic activation of the assist motor 7 and which is characteristic of the pursued property, then an analysis step (c), during which the pursued property is quantified from the measurement(s) of the indicator parameter.

Although it is not excluded to punctually use a calculator 13 external to the power steering system 1, that would be electrically connected to said system 1 when it is desired to proceed with the characterization of the latter, said calculator 13 may preferably be an integral part of the power steering system 1, and therefore of the vehicle equipped with said system 1, and form to this end a second onboard module, called «characterization module» 13.

Preferably, the first module, namely the assist module 8 used for assisting steering during the piloting phase, and the second module, namely the characterization module 13 intended to monitor the automated process of characterizing the power steering system 1 off the piloting phase will co-exist within the same calculator onboard the vehicle.

Advantageously, the invention allows intrinsically using the assist motor 7 embedded in the power steering system 1 as an exclusive drive source to drive the steering mechanism 3 during the characterization, without requiring an external active movement source, such as the manual force of an operator or an external additional motor, that would be distinct from the assist motor 7 (and for example integrated to a robotized arm).

Hence, more generally, the characterization according to the invention may advantageously be carried out without it being necessary to mechanically act in an active way, whether manually or by an external motor, on the power steering system 1, and more particularly on the steering mechanism 3, from the outside, and more particularly without it being necessary to actuate, whether manually or by an external motor, any of the movable mechanical members, such as the steering wheel 2, an apparent end of the rack 4, or possibly a steering tie rod 6 or a wheel 5 linked to said rack 4, that form a mechanical interface between said power steering system 1, respectively said steering mechanism 3, and the outside thereof.

Hence, the actuation of the steering mechanism 3 for the characterization according to the invention may be carried out in a standalone, easy manner and at a lesser cost, by exclusively exploiting drive means (assist motor 7), and where appropriate control means (characterization module 13), that are intrinsically present in the power steering system 1.

Moreover, it should be noted that it is possible to provide for using one or several passive external load(s), such as for example blocking wedges, springs and/or dampers, that are coupled to either one or both of the mechanical interfaces of the power steering system 1 (steering wheel 2 or ends of the rack 4, for example) in order to simulate a particular behavior of the steering system 1 and thus access to the pursued property.

Nonetheless, these external loads will be passive, that is to say, unlike the assist motor 7, they will not intrinsically bring in energy to the power steering system, but will rather serve to dissipate all or part of the energy imparted to the steering mechanism 3 by said assist motor 7 or to modify the distribution of said energy over time and through said steering mechanism 3.

As indicated hereinabove, the characterization method according to the invention takes place off any piloting phase of a vehicle, in a test situation that may be qualified as “virtual” situation, since said situation does not require complying with a particular path or with a particular dynamic behavior of the vehicle, and therefore allows characterizing the power steering system 1 as such, irrespective of the influence of the vehicle, by de-correlating the use of said power steering system 1 from the use of the vehicle itself, and consequently without imposing on the characterization method restrictions related to safety of said vehicle or of the occupants of the latter.

Thus, the method according to the invention will be particularly suited to the characterization in factory, off traffic, typically on a test bench, of a vehicle equipped with a power steering system 1, or even of a power steering system 1 alone, before assembly of said system 1 on a vehicle, and for example of a power steering system 1 on which the wheels 5, and where appropriate the steering tie rods 6 have not yet been installed.

Since step (a) of automatic activation for the characterization takes place off a vehicle piloting phase, it is advantageously possible to control the assist motor 7 by means of an exploration cycle CY, and therefore of an activation setpoint, whose nature, form and duration, defined according to a predetermined activation diagram («pattern»), will be arbitrarily and freely selected, so as to be able to determine the pursued property, in an optimum manner, and without having to comply with a compulsory path of a vehicle, and in particular without having to take into consideration safety of the vehicle, of the occupants of said vehicle, or of the persons or objects present in the environment of said vehicle.

In practice, it will therefore be possible to define and apply the exploration cycles CY, and more generally the activation setpoint applied to the assist motor 7 during the characterization method, without the need for acquiring (and in particular measuring) or taking into consideration parameters representative of the dynamics specific to the vehicle with respect to its environment, that is to say parameters representative of the behavior specific to the vehicle within a reference frame external to said vehicle, amongst which in particular the longitudinal speed of the vehicle, the lateral acceleration of said vehicle, the yaw speed of said vehicle, or the distance of the vehicle from an obstacle or from an external reference (for example a white line delimiting the traffic lane) detected within said external reference frame.

In this manner, said exploration cycles will not be subjected to any restriction related to such parameters representative of the dynamics of the vehicle, and, in practice, will not therefore require for their definition and their application, any external information input related to such parameters, and in particular any visual information input.

Thus, it will be possible to activate the assist motor 7 without having to input information concerning parameters representative of the dynamics of the vehicle within its environment, which information input would be carried out either by the senses (in particular tactile and visual) of a human driver, who would react afterwards to this information by manually actuating the steering wheel 2, or through an automatic acquisition process (for example by means of a camera or a radar, in particular laser, infrared or ultrasonic) which would be implemented by an automatic piloting module.

At most, said exploration cycles may possibly be dimensioned so as to comply with some material limitations inherent to the design of the power steering system 1 itself, such as for example the maximum torque that the assist motor 7 can output (and therefore the maximum electric current that said assist motor 7 can tolerate without damage).

As illustrated in FIG. 2, the exploration cycle may preferably include at least one sign change, which corresponds to a reversal of the direction of activation of the assist motor 7, so as to activate said assist motor 7 to the right, and then to the left (or vice versa).

Thus, a so-called «elementary» exploration cycle may preferably comprise a positive alternation and a negative alternation.

Nonetheless, it is of course possible to alternatively use an elementary cycle comprising one single alternation, with a constant sign, for example positive, in order to load the assist motor 7 only in one direction, to the right or on the contrary to the left, if this is enough to define the pursued property.

Of course, each elementary exploration cycle CY may be repeated as many times as necessary, preferably identically, without exceeding a predetermined number of iterations Ni.

Where appropriate, the repetition of the exploration cycles CY will allow multiplying, during the successive cycles, the measurements of the same indicator parameter, for example at the rate of at least one, and even exactly one, measurement of said indicator parameter per cycle.

By thus using a plurality of successive measurements of the same indicator parameter over several cycles to quantify the pursued property, and for example by using to this end an arithmetic average or a weighted average of the different measurements of said indicator parameter over several cycles, and even a selection of said measurements excluding values deemed to be doubtful, it is advantageously possible to improve the accuracy and the reliability of the analysis step (c), during which the pursued property is quantified from said indicator parameter, respectively from said average.

Of course, during the measurement step (b), the reactions of the power steering system 1, and more particularly of the steering mechanism 3, to the mechanical constraints created by the activation of the assist motor 7, are observed by measuring and possibly recording as many indicator parameters as necessary to determine the pursued property from said observed response.

In particular, it is possible to measure, as needed, one or several indicator parameter(s) among: the position P7 (and therefore the displacements) of the shaft of the assist motor 7, the position (and therefore the displacements) P4 of the movable member 4 (rack) or the position P2 (and therefore the displacements) of the steering wheel 2, preferably expressed in the reference frame of the assist motor 7, the speed P7′, P4′, P2′ and in particular the angular speed (preferably expressed in the reference frame of the motor 7, while taking into consideration the possible mechanical transmission ratios) of either one of these components 7, 4, 2, the force T7 delivered by the assist motor 7, the steering wheel torque T2, or a resisting force T4 exerted by an external element on the movable member (rack) 4 against the assist motor 7.

For convenience of the description, it is possible to add in what follows the suffix «_mes» to explicitly refer to an indicator parameter (measured or assessed) associated to a given quantity, in particular when it is necessary to explicitly differentiate the effective value measured by said indicator parameter from a corresponding setpoint value. Nonetheless, for convenience of the description, it is generally possible to assimilate the indicator parameter (measured effective value) to the corresponding setpoint.

Preferably, the method allows determining at least one pursued property, and even more preferably several (at least two) pursued properties, among:
a stiffness K characteristic of the elasticity of a portion of the steering mechanism 3,
a temperature rise or a thermal evolution pattern of the assist motor 7,
an endurance property characterized by a wear indicator, such as a degree of wear of the steering mechanism 3 or of the assist motor 7, as a function of a number Ni of back-and-forth cycles CY performed by the steering mechanism 3.

These different possibilities provided by the invention will be detailed hereinafter.

According to a first possibility of the invention, during the activation step (a), a force exploration cycle CY_force, or a succession of several force exploration cycles CY_force, is applied where each force exploration cycle CY_force servo-controls the force T7 of the assist motor 7, and more particularly servo-controls the torque T7 of the assist motor 7, according to at least one non-zero force setpoint (torque setpoint) T7, T7_1, T7_2.

An example of an elementary force exploration cycle CY_force is illustrated in FIG. 2.

Preferably, said force exploration cycle CY_force comprises at least one first alternation 20, conventionally positive, which activates the assist motor 7 to the right.

Preferably, the force exploration cycle CY_force also comprises, thereafter, a second alternation 120, with an opposite sign, and therefore negative, which activates the motor 7 in the opposite direction, herein conventionally to the left.

Preferably, the first alternation 20, respectively the second alternation, comprises an ascending phase (in absolute value) 22, 122 herein over a time frame [t2; t3], respectively [t6; t7], preferably in the form of a ramp, during which the torque setpoint (force setpoint) passes from a zero value to a peak value T7_1, T7_2, then possibly a plateau hold phase 23, 123 during which said torque setpoint (force setpoint) is held at said peak value T7_1, T7_2 for a predetermined duration, herein over the time frame [t3; t4], respectively [t7; t8], then a descending phase (in absolute value) 24, 124, preferably in the form of a ramp, herein over a time frame [t4; t5], respectively [t8; t9], during which the torque setpoint (force setpoint) is brought back to zero.

For convenience and safety of programming, the peak value T7_1 is preferably expressed as a percentage of the acceptable maximum torque (acceptable maximum force) T7_max that the assist motor 7 can output.

In order to ensure a perceptible activation of the assist motor 7, while avoiding a damage of said motor 7, the peak value T7_1 is strictly comprised between 0% and 100% of the acceptable maximum torque (acceptable maximum force) T7_max, and preferably comprised between 30% and 90%, or more preferably between 50% and 80% of said acceptable maximum torque.

Preferably, we choose T7_2=−T7_1, so as to apply alternations 20, 120 with a substantially symmetrical amplitude, to the right and to the left.

It is also possible to provide for one or several rest phase(s) 21 [t1; t2], 121 [t5; t6], 25 [t9; t10], during which a substantially zero torque setpoint is held, which may serve for example to calibrate the sensors during the cycle.

Moreover, the respective durations of the different phases of the cycle, and in particular of the plateau hold phases 23, 123, will be selected to be long enough so as to sufficiently stabilize the power steering system 1, and more particularly the steering mechanism 3 and the assist motor 7, in a stable regime, preferably permanent, and thus accurately measure the desired indicator parameter(s), such as a the effective position P7_mes of the assist motor 7, the effective position P4_mes of the rack (or that of the steering wheel P2_mes), as well as the effective assist torque (motor torque) T7_mes or an effective force (typically an axial tensile or compressive force) T4_mes exerted on the rack 4. For example, it is possible to choose to this end hold times that are equal to or longer than the 95% response time to a step-type setpoint.

During the application of the force exploration cycle(s) CY_force, it is possible to block a movable member 4 of the steering mechanism, for example it is possible to block the rack 4, against the assist motor 7.

To this end, it is possible to use a blocking wedge (or any similar locking device), which immobilizes one end of the rack 4, or possibly which immobilizes the steering tie rod 6 or the wheel 5, with respect to a fixed frame on which the steering casing is also fastened. Thus, the rack 4 will be immobilized with respect to said steering casing.

Advantageously, it is then preferably possible to measure, during the measurement step (b), at least one force indicator parameter T7_mes, T4_mes, representative of the forces subjected to the blocked movable member 4, as well as at least one displacement indicator parameter P7_mes, P4_mes, representative of the relative displacement P7_mes-P4_mes performed by the assist motor 7 against said blocked movable member 4, in order to quantify, during the analysis step (c), an elastic stiffness property, also called «flexibility» property, of the corresponding portion of the steering mechanism 3.

Thus, the stiffness K of a portion of the steering mechanism 3 may be assessed by applying a force exploration cycle CY_force.

More particularly, it is possible to measure, in the same reference frame, for example the reference frame of the assist motor 7, the (angular) position P7_mes reached by the shaft of said motor 7 under the assist torque setpoint T7 (also called «motor torque» setpoint), and that more particularly when the peak value: T7=T7_1 is applied, with regards to the position P4 of the blocked rack 4, which is almost invariant because of the blocking ensured by the wedge.

The motor torque T7 will correspond, while taking into account a possible reduction ratio, to the force exerted by the motor 7 on the rack 4, that is to say to the force T4 subjected to the rack 4, and which is compensated, when the rack 4 is in a static equilibrium, by the retaining force exerted by the blocking wedge against said rack.

For example, said motor torque T7 may be assessed by means of a torque sensor integrated to the assist motor 7 which measures an effective motor torque T7_mes, or else by knowing the magnitude of the power supply current that crosses the assist motor 7.

The force T4 subjected to the rack, such as said force results from the stresses exerted on said rack 4, causes, by elastic deformation, a differential displacement P7-P4 between the shaft of the motor 7 and the rack 4.

Of course, this force T4 may be determined by any other equivalent means, for example by means of a strain gauge that would be glued on the rack.

The differential displacement ΔP=p7−P4 being due to the intrinsic elasticity of the components and of the mechanical linkages that connect the assist motor 7 to the rack 4, it is therefore possible to assess the stiffness K of this mechanism portion as being equal, at a given time, to the ratio of the motor torque T7, T7_1 to the differential displacement P7−P4, as:

T7=K*ΔP=K*(P7−P4).

Of course, it is alternatively possible to block the entire movable member 4, 2 driven by the assist motor 7, other than the rack, so as to allow studying the elasticity of the corresponding portion, comprised between said motor 7 and said blocked member 4, 2.

Thus, according to another variant of implementation based on a similar principle, it is possible, if the steering system 1 comprises a steering wheel 2 mechanically connected to the steering mechanism 3 through a steering column 10, and therefore prone to be driven in rotation by the assist motor 7, to block the steering wheel 2 while the force exploration cycle CY_force is applied to the assist motor 7.

The relative movement ΔP=P7−P2 of the shaft of the assist motor 7 relative to the blocked steering wheel 2 is then essentially due to the elasticity of the torque sensor 9 placed on the steering column 10, and more particularly the elasticity of a torsion bar integrated to said torque sensor 9, whose stiffness K may herein be determined from the expression:

T7=K*ΔP=K*(P7−P2).

It should be noted that it is possible, according to a variant of application of the force exploration cycle CY_force, to carry out a thermal test of the assist motor 7 by using a force exploration cycle CY_force (in particular as described hereinabove with reference to FIG. 2), or by using a succession of several force exploration cycles CY_force, in particular repeated a predefined number of iterations Ni.

To this end, during said force exploration cycle(s), it is possible to measure, as an indicator parameter, the temperature of the assist motor 7.

For example, this measurement may aim at determining the reached maximum temperature as a function of the applied peak torque T7_1 and/or as a function of the duration of application of said force.

In particular, it is possible for example to choose to apply one single alternation 20, comprising a long plateau phase 23, during which the force setpoint T7 is persistently held at a constant torque value T7_1, which may for example get close to the acceptable maximum torque T7_max, and for example represent up to 80%, 90%, 95%, or 100% of said acceptable maximum torque T7_max, for a duration equal to or longer than 15 seconds, and for example comprised between 15 s and 300 s, or beyond, in order to activate the assist motor 7 according to an uninterrupted permanent regime.

Alternatively, it is possible for example to apply a series of elementary force exploration cycles CY_force each comprising either one single alternation, or two opposite alternations 20, 120, preferably with equal values and plateau durations, and by defining, or varying over several tests, the ratio, or «duty cycle», between the activation duration (and more particularly the cumulated duration of the plateau hold phases 23, 123) and the cumulated duration of the cycles (including the activation phases and the rest phases 21, 121, 25).

Preferably, in any case, whether applying one or several alternation(s), and/or repeating or not the force exploration cycle CY_force, it is possible to block a movable member 4, and in particular the rack 4, in order to be sure that the assist motor 7 reaches the peak torque T7_1, or its maximum torque T7_max, which typically corresponds to its short-circuit current, rapidly and with a small amplitude of displacement.

Moreover, the characterization method may also include, during the activation step (a), a safeguarding substep (a1), during which the motor torque setpoint T7 applied to the assist motor 7 is clipped in order to keep said torque setpoint below (in absolute value) a predetermined safety threshold T7_safe, said safety threshold T7_safe being adjusted, and more particularly reduced, when approaching a limit position Xlim that should not be exceeded, and for example when approaching an end-of-stroke stop S1, S2.

To this end, a function, called «safeguarding function», is used which defines, as illustrated in FIG. 3, in a reference frame associating a steering wheel torque T7 (in ordinate) to a value representative of the position P7, P4, P2 of the steering mechanism, and more preferably representative of the position P4 of the rack 4, on the one hand an authorized domain D1 (blank in FIG. 3) and, on the other hand, a prohibited domain D2 (hatched in FIG. 3), whose boundary corresponds to the safety threshold T7_safe.

It should be noted that, in each considered direction of displacement (to the right, respectively to the left), the safety threshold T7_safe is lowered (that is to say its absolute value decreases), from a safety position Xsafe that precedes the limit position Xlim in the considered direction of displacement, and preferably until becoming zero when said limit position Xlim is reached.

To this end, the safeguarding function may form a ramp decreasing from the safety position Xsafe down to the limit position Xlim.

Thus, it is possible to force a progressive slow-down of the steering mechanism 3 to avoid exceeding the limit position Xlim, and more particularly hitting against the stop S1 (when the used exploration cycle does not aim at determining the position of said stop, of course), when getting close to said limit position Xlim.

However, since it is not necessary to brake the mechanism 3 when getting away from the limit position Xlim, the safety threshold T7_safe may directly return back to its maximum value (plateau value), as illustrated by the rectangular corner like shaped boundary of the authorized domain D1 in FIG. 3.

Preferably, the limit position Xlim is defined as a percentage, for example comprised between 75% and 100%, and more particularly between 80% and 95% of the position of the corresponding end-of-stroke stop S1, S2.

Of course, the invention also concerns as such a power steering system 1 allowing implementing all or part of the aforementioned characterization methods.

Thus, the invention concerns more particularly a power steering system 1 which comprises a characterization module 13 forming a complete characterization «toolbox», containing and allowing implementing an exploration cycle selectively among a plurality of available exploration cycles, and that in particular in order to facilitate the automatic calibration and fine-tuning of the system 1 in factory.

Thus, the invention concerns a power steering system 1 intended to equip a vehicle and comprising at least one heading definition device 2, such as a steering wheel, which enables a driver to define a steering angle A1 of the power steering system, a steering mechanism 3 provided with at least one movable member 4, such as a rack, whose position P4 adapts so as to correspond to the selected steering angle A1, as well as at least one assist motor 7 arranged so as to be able to drive said steering mechanism 3, said power steering system 1 including on the one hand a first onboard module 8, called «assist module» 8, which contains a first set of functions called «assist laws», which allow generating, when the power steering system 1 is dedicated to driving of a vehicle, piloting setpoints towards the assist motor 7, in order to make said vehicle follow a path that is determined according to the situation of said vehicle with respect to its environment, and on the other hand a second onboard module 13, called «characterization module» 13, which contains a second set of functions, called «characterization functions», distinct from the assist laws, and which allow implementing, during a period where the power steering system is not dedicated to driving of a vehicle, and automatically, a characterization method intended to empirically determine at least one property of said power steering system, called «pursued property».

Like the assist module 8, the characterization module 13 preferably consists of an electronic or computer module.

As indicated hereinabove, said characterization method comprises a step (a) of automatically activating the assist motor 7, during which the second onboard module 13 automatically generates and applies to the assist motor 7, without requiring any external action on the heading definition device 2, an activation setpoint T7, V7, P7 which follows one or several pre-established cycle(s) called «exploration cycles» CY, in order to enable a measurement step (b), according to which is measured, during the exploration cycle(s) CY or on completion of said exploration cycle(s) CY, at least one physical parameter, called «indicator parameter» P7_mes, T7_mes, P4_mes, T2_mes, V2_mes, etc., which is specific to the response supplied by the power steering system 1 to the automatic activation of the assist motor 7 and which is characteristic of the pursued property, then an analysis step (c), during which the pursued property is quantified from the measurement(s) of the indicator parameter.

Hence, the characterization module 13, as well as the assist module 8, will preferably be integrated to the steering system 1, and in particular integrated to an onboard calculation module which may be used in a standalone manner.

The characterization functions, and more particularly the exploration cycles CY that these characterization functions automatically implement, may advantageously be stored in a non-volatile memory of the characterization module 13, for example in the form of libraries of functions (dll files) programmed in said characterization module 13 and/or mappings («maps»).

Thus, the characterization module 13 will contain a plurality of pre-established exploration cycles CY, for example so as to allow selectively activating, besides the vehicle piloting phase, a cycle CY selected from the exploration cycles described in the foregoing.

Preferably, the second onboard module (characterization module) 13 includes a stiffness characterization function which uses a force exploration cycle CY_force which applies a non-zero torque setpoint T7 to the assist motor 7, whereas a movable member 4, 2 of the steering is blocked against the assist motor, and which measures the displacement performed by said assist motor 7 against said blocked movable member 4, 2, in order to determine a stiffness K characteristic of the elasticity of a corresponding portion of the steering mechanism 3.

Preferably, the characterization module 13 will also comprise a selector allowing selecting and executing either one of said available characterization functions, separately from the other characterization functions and assist functions, and thus control automatically, and in a standalone manner, the assist motor 7 for characterization, independently of the piloting of the vehicle.

Of course, the invention is not limited to the sole variants described in the foregoing, those skilled in the art being in particular able to freely isolate or combine together the aforementioned features, or substitute them with equivalents.

1. A method for characterizing a power steering system intended to empirically determine at least one property of said power steering system, called «pursued property», said power steering system comprising at least one heading definition device, which allows defining the orientation, called «steering angle» of the power steering system, a steering mechanism provided with at least one movable member, whose position adapts so as to correspond to the selected steering angle, as well as at least one assist motor arranged so as to be able to drive said steering mechanism, said method comprising, besides a piloting phase during which the power steering system is dedicated to driving of a vehicle in order to make said vehicle follow a path that is determined according to the situation of said vehicle with respect to its environment, a step of automatically activating the assist motor, during which a calculator is used to automatically generate and apply to the assist motor, without requiring any external action on the heading definition device, an activation setpoint which follows one or several pre-established cycle(s) called «exploration cycles», a measurement step (b) according to which is measured, during the exploration cycle(s) or on completion of said exploration cycle(s) at least one physical parameter, called «indicator parameter», which is specific to the response supplied by the power steering system to the automatic activation of the assist motor and which is characteristic of the pursued property, then an analysis step (c), during which the pursued property is quantified from the measurement(s) of the indicator parameter, wherein during the automatic activation step (a), a force exploration cycle or a succession of several force exploration cycles is applied, where each force exploration cycle servo-controls the force, of the assist motor, according to at least one non-zero force setpoint.

2. The characterization method according to claim 1, wherein during the application of the force exploration cycle(s), a movable member of the steering mechanism, for example a rack, is blocked against the assist motor, and in that, during the measurement step (b), is measured at least one force indicator parameter, representative of the forces subjected to the blocked movable member, and at least one displacement indicator parameter, representative of the displacement performed by the assist motor against said blocked movable member, in order to quantify, during the analysis step (c), an elastic stiffness property of the corresponding portion of the steering mechanism.

3. The characterization method according to claim 1, wherein a force exploration cycle, or a succession of several force exploration cycles, is used during which is measured, as an indicator parameter, the temperature of the assist motor so as to carry out a thermal test of said assist motor.

4. The characterization method according to claim 1, wherein it allows determining at least one pursued property, among:
a stiffness characteristic of the elasticity of a portion of the steering mechanism,
a temperature rise or a thermal evolution pattern of the assist motor,
an endurance property wherein a wear indicator as a function of a number (Ni) of back-and-forth cycles performed by the steering mechanism.

5. A power steering system intended to equip a vehicle and comprising at least one heading definition device, which enables a driver to define a steering angle of the power steering system, a steering mechanism provided with at least one movable member, whose position adapts so as to correspond to the selected steering angle, as well as at least one assist motor arranged so as to be able to drive said steering mechanism, said power steering system including on the one hand a first onboard module, called «assist module», which contains a first set of functions called «assist laws», which allow generating, when the power steering system is dedicated to driving of a vehicle, piloting setpoints towards the assist motor, in order to make said vehicle follow a path which is determined according to the situation of said vehicle with respect to its environment, and on the other hand, a second onboard module, called «characterization module», which contains a second set of functions, called «characterization functions», distinct from the assist laws, and which allow implementing, during a period where the power steering system is not dedicated to driving of a vehicle, and automatically, a characterization method intended to empirically determine at least one property of said power steering system, called «pursued property», said characterization method comprising a step (a) of automatically activating the assist motor during which the second onboard module automatically generates and applies to the assist motor without requiring any external action on the heading definition device, an activation setpoint which follows one or several pre-established cycle(s) called «exploration cycles», in order to enable a measurement step (b), according to which is measured, during the exploration cycle(s) or on completion of said exploration cycle(s), at least one physical parameter, called «indicator parameter», which is specific to the response supplied by the power steering system to the automatic activation of the assist motor and which is characteristic of the pursued property, then an analysis step (c), during which the pursued property is quantified from the measurement(s) of the indicator parameter, wherein during the automatic activation step (a), a force exploration cycle, or a succession of several force exploration cycles, is applied, where each force exploration cycle servo-controls the force of the assist motor, according to at least one non-zero force setpoint.

6. The power steering system according to claim 5, wherein the second onboard module groups together a stiffness characterization function which uses a force exploration cycle which applies to the assist motor a non-zero torque setpoint, whereas a movable member of the steering is blocked against the assist motor, and which measures the displacement performed by said assist motor against said blocked movable member, in order to determine a stiffness characteristic of the elasticity of a corresponding portion of the steering mechanism.

7. The characterization method according to claim 2, wherein a force exploration cycle, or a succession of several force exploration cycles, is used during which is measured, as an indicator parameter, the temperature of the assist motor so as to carry out a thermal test of said assist motor.

8. The characterization method according to claim 2, wherein it allows determining at least one pursued property, among:
a stiffness characteristic of the elasticity of a portion of the steering mechanism,
a temperature rise or a thermal evolution pattern of the assist motor,
an endurance property wherein a wear indicator as a function of a number (Ni) of back-and-forth cycles performed by the steering mechanism.

9. The characterization method according to claim 3, wherein it allows determining at least one pursued property, among:
a stiffness characteristic of the elasticity of a portion of the steering mechanism,
a temperature rise or a thermal evolution pattern of the assist motor,
an endurance property wherein a wear indicator as a function of a number (Ni) of back-and-forth cycles performed by the steering mechanism.

10. The characterization method according to claim 7, wherein it allows determining at least one pursued property, among:
a stiffness characteristic of the elasticity of a portion of the steering mechanism,
a temperature rise or a thermal evolution pattern of the assist motor,
an endurance property wherein a wear indicator as a function of a number (Ni) of back-and-forth cycles performed by the steering mechanism.
